(19) United States
(12) Patent Application Publication
(10) Pub. No.: US 2005/0111796 A1
(43) Pub. Date: May 26, 2005

(54) Adaptor for reducing EMI

(76) Inventors: Jeffrey A. Matasek, Woodridge, IL (US); Igor Grois, Northbrook, IL (US)

Correspondence Address: MOLEX INCORPORATED, 2222 WELLINGTON COURT, LISLE, IL, 60532, US

(21) Appl. No.: 10/722,829

(22) Filed: Nov. 26, 2003

(51) Int. Cl. G02B 6/38

(52) U.S. Cl. 385/55

(57) ABSTRACT

A fiber optic adaptor includes a unitary metal housing and two latches which are snap fit within the housing. An internal wall is provided with an aperture there through to reduce electromagnetic interference.

### BACKGROUND OF THE INVENTION

This invention is generally directed to an adaptor which is used to mate fiber optic cables.

A problem encountered in many electrical systems is electromagnetic interference (EMI). Shielding is usually provided to block electrical components in the electrical system from EMI.

Prior art fiber optic adaptors provide an outer housing formed of plastic which receives the fiber optic latches. Two molded plastic portions are ultrasonically welded together to form the outer housing and an EMI plate is provided between the molded plastic portions to provide shielding. Such an adaptor, therefore, requires ultrasonic welding of the portions of the outer housing and the formation and attachment of an EMI plate.

Therefore, it is desirable to provide an adaptor which provides EMI shielding. In addition it is desirable to provide an adaptor which can easily manufactured without using ultrasonic welding. The present invention provides such an adaptor. Other features and advantages will become clear upon a reading of the attached specification in combination with a study of the drawings.

### OBJECTS AND SUMMARY OF THE INVENTION

A general object of the present invention is to provide an adaptor for mating two fiber optic cables.

An object of the present invention is to provide an adaptor with EMI protection.

Another object of the present invention is to provide an adaptor which can be formed without welding.

A further object of the present invention is to provide an adaptor which can be easily assembled.

Briefly, and in accordance with the foregoing, the present invention discloses an adaptor for mating fiber optic cables. The adaptor includes a unitary metal outer housing and two latches which are snap-fit within the outer housing. The housing provides an internal wall which reduces the aperture through which the optical signal passes and therefore reduces EMI.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is an exploded perspective view of an adaptor which incorporates the features of the invention;

FIG. 2 is a cross-sectional perspective view of the adaptor of FIG. 1 shown from the second end and in the assembled condition;

FIG. 3 is a perspective view of the adaptor of FIG. 1 shown in the assembled condition; and

FIG. 4 is a perspective view of a second embodiment of an adaptor which incorporates features of the invention.

### DETAILED DESCRIPTION OF THE ILLUSTRATED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

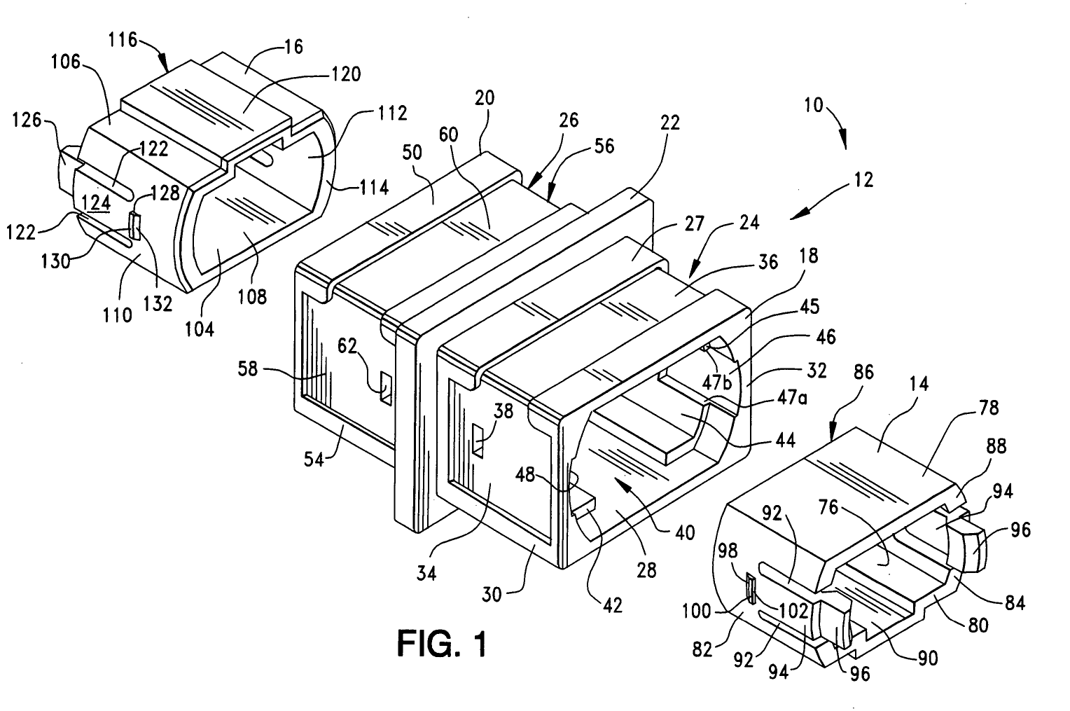

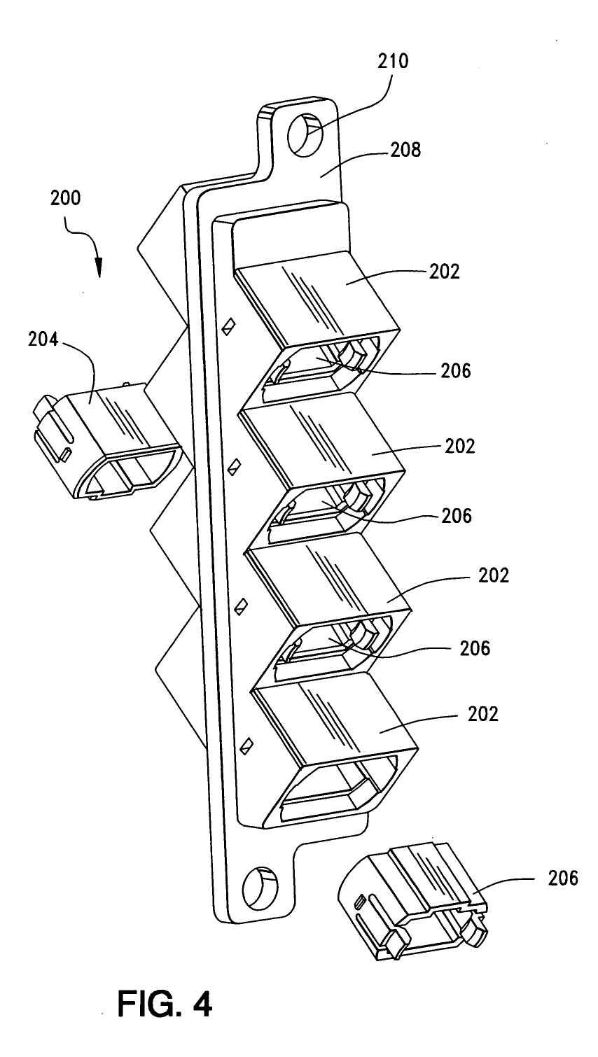

The adaptor of the present invention is used to mate two fiber optic cables. A first embodiment of the adaptor is shown in FIGS. 1-3. A second embodiment of the adaptor is shown in FIG. 4.

The adaptor 10 generally includes a central housing 12, a first latch 14 which mates with the central housing 12 and a second latch 16 which mates with the central housing 12.

The central housing 12 is a unitary piece and is generally rectangular in shape. The central housing 12 is formed from metal and preferably the central housing 12 is formed from diecasted metal. Because the central housing 12 is a unitary piece, sonic welding is not required to assemble the central housing 12. The central housing 12 includes a first end 18 and a second end 20. An outwardly extending flange 22 is provided midway between the first end 18 and the second end 20. A first latch portion 24 extends from the first end 18 to the flange 22 and a second latch portion 26 extends from the second end 20 to the flange 22.

The first latch portion 24 includes a top wall 27, a bottom wall 28, and side walls 30, 32 each extending from the flange 22 to the first end 18. A recess 34 is provided in the outer surface of each side wall 30, 32 of the first latch portion 24 and a recess 36 is provided in the outer surface of the top wall 26 of the first latch portion 24. The recesses 34 in the side walls 30, 32 are in communication with the recess 36 provided in the top wall 26 of the first latch portion 24. An aperture 38, which is spaced from the flange 22, is provided through each side wall 30, 32 for retaining the first latch 14 as will be described herein. The apertures 38 are aligned with each other.

The first latch portion 24 of the central housing 12 includes a first latch cavity 40 defined by the inner surfaces of the top wall 26, the bottom wall 28, and the side walls 30, 32. The first latch cavity 40 is generally oblong shaped to receive a latch, preferably an MPO type latch. Generally V-shaped rails 42, 44 are provided on either side of the first latch cavity 40. A first rail 42 extends from the inner surfaces of the side wall 30 and the bottom wall 28. A second V-shaped rail 44 extends from the inner surfaces of the side wall 32 and the bottom wall 28. The V-shaped rails 42, 44 guide the latch 14 within the cavity 40 as will be described herein. A generally U-shaped guiding structure 45 is provided on the inner surface of the top wall 26 and extends along the inner surfaces of the side walls 30, 32. The guiding structure 45 guides the latch 14 within the cavity 40 as will be described herein. A recess 46 is provided on the inner surface of the side wall 32. The recess 46 in connection with the V-shaped rail 44 provides a shoulder 47a and the recess 46 in connection with the guiding structure 45 provides a shoulder 47b. The shoulders 47a, 47b assist the alignment of the latch 14 within the latch cavity 40. A recess 48 is provided on the inner surface of the sidewall 30. The recess 48 in connection with the V-shaped rail 42 provides a shoulder (not shown) and the recess 48 in connection with the guiding structure 45 provides a shoulder (not shown). The shoulders on the side wall 30 assist the alignment of the latch 14 within the latch cavity 40.

The second latch portion 26 includes a top wall 50, a bottom wall 52, and side walls 54, 56 each extending outwardly from the flange 22, opposite the first latch portion 24. A recess 58 is provided in the outer surface of each side wall 54, 56 of the second latch portion 26 and a recess 60 is provided in the outer surface of the top wall 50. The recesses 58 in each side wall 54, 56 are in communication with the recess 60 of the top wall 50. An aperture 62, which is spaced from the flange 22, is provided through each side wall 54, 56 for retaining the second latch 16 as will be described herein. The apertures 62 are aligned with each other.

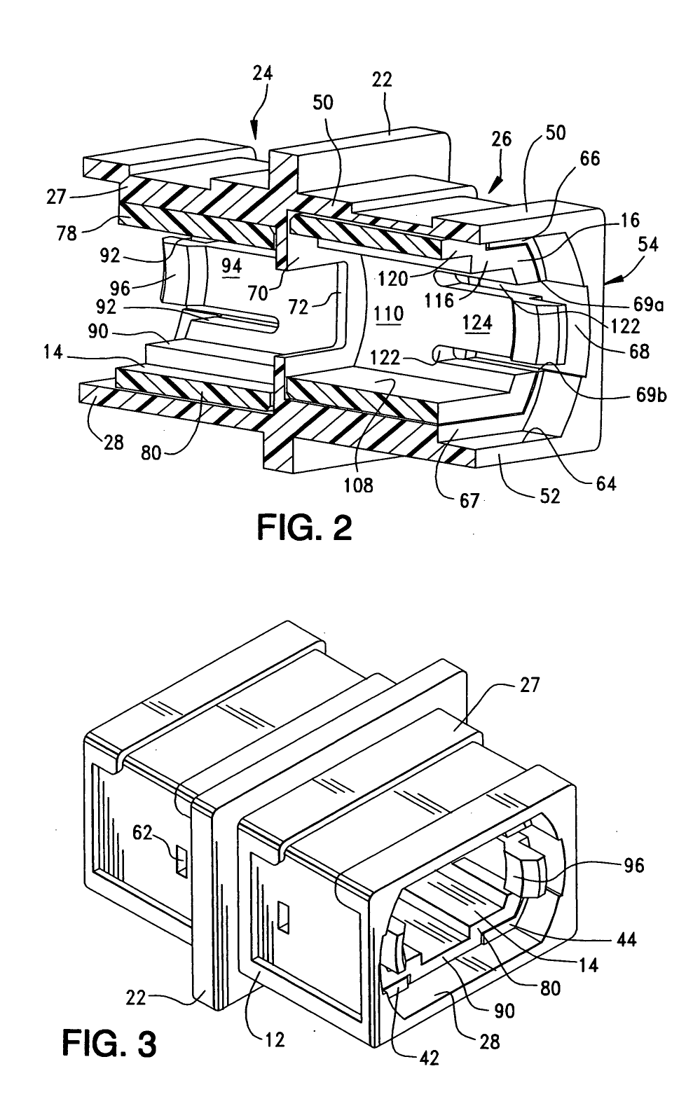

As best shown in FIG. 2, the second latch portion 26 of the central housing 12 includes a second latch cavity 64 defined by the inner surfaces of the top wall 50, the bottom wall 52, and the side walls 54, 56. The second latch cavity 64 is generally oblong shaped to receive a latch, preferably an MPO type latch. The second latch cavity 64 is identical to the first latch cavity 40 however it is rotated 180 degrees. Generally V-shaped rails, one of which is shown in FIG. 2, are provided on either side of the second latch cavity 64. A first rail 66 extends from the inner surfaces of the sidewall 54 and the top wall 50. A second V-shaped rail 66 extends from the inner surfaces of the sidewall 56 and the top wall 50. The V-shaped rails 66 guide the latch 16 within the second latch cavity 64 as will be described herein. A generally U-shaped guiding structure 67 is provided on the inner surface of the bottom wall 52 and extends along the inner surfaces of the side walls 54, 56. The guiding structure 67 guides the latch 16 within the cavity 64 as will be described herein. A recess 68 is provided on the inner surface of the side wall 54. The recess 68 in connection with the V-shaped rail 66 provides a shoulder 69a and the recess 68 in connection with the guiding structure 67 provides a shoulder 69b. The shoulders 69a, 69b assist the alignment of the latch 16 within the latch cavity 64. A recess (not shown) is also provided on the inner surface of the sidewall 56. The recess (not shown) in connection with the V-shaped rail (not shown) provides a shoulder (not shown) and the recess in connection with the guiding structure 67 provides a shoulder (not shown). The shoulders on the side wall 52 assist the alignment of the latch 16 within the latch cavity 64.

As illustrated in FIG. 2, an internal wall 70 is formed as part of the central housing 12 between the first latch cavity 40 and the second latch cavity 64. The internal wall 70 extends from the inner surfaces of the top walls 26, 50, bottom walls 28, 52 and side walls 30, 32, 54, 56 and is generally aligned with the flange 22. An internal wall aperture 72 is provided through the internal wall 70 and provides communication between the first latch cavity 40 and the second latch cavity 64. The internal wall aperture 72 is generally rectangularly shaped. The height and width of the internal wall aperture 72 are smaller than the height and width of the latch cavities 40, 64.

As shown in FIG. 1, the first latch 14 is generally oblong in shape and includes a fiber passageway 76 there through. The first latch 14, is preferably formed from plastic. The first latch includes a top wall 78, a bottom wall 80, side walls 82, 84, an inner end 86 and an outer end 88. A central portion 90 of the bottom wall 80 extends outwardly from the remainder of the bottom wall 80. Elongated grooves 92 are provided through each side wall 82, 84 and extend inwardly a predetermined distance from the outer end 88 toward the inner end 86. A cantilevered latch arm 94 is provided between the grooves 92 on each side wall 82, 84. A portion of each latch arm 94 is offset to form a finger latch 96 at an outer free end of each latch arm 94. A tooth 98 extends outwardly from the outer surface of each side wall 82, 84 proximate an inner end of the latch arm 94. Each tooth 98 includes a sloped surface 100 which is angled relative to the respective side wall 82, 84 and a retaining surface 102 which is approximately perpendicular to the respective side wall 82, 84 of the first latch 14. The shape and the dimensions of the first latch 14 are such that the first latch 14 can be positioned within the first latch cavity 40 of the central housing 12.

The second latch 16 is identical to the first latch 14 however it is rotated 180 degrees. The second latch 16 is generally oblong in shape and includes a fiber passageway 104 there through. The second latch includes a top wall 106, a bottom wall 108, side walls 110, 112, an inner end 114 and an outer end 116. A central portion 120 of the top wall 106 extends outwardly from the remainder of the top wall 106. Elongated grooves 122 are provided through each side wall 110, 112 and extend inwardly a predetermined distance from the outer end 116 towards the inner end 114. A cantilevered latch arm 124 is provided between the grooves 122 on each side wall 110, 112. A portion of the latch arm 124 is offset to form a finger latch 126 at an outer free end of each latch arm 124. A tooth 128 extends outwardly from the outer surface of each side wall 110, 112 proximate an inner end of the latch arm 124. Each tooth includes a sloped surface 130 which is angled relative to the respective side wall 110, 112 and a retaining surface 132 which is approximately perpendicular to the respective side wall 110, 112 of the second latch 16. The shape and the dimensions of the second latch 16 are such that the second latch 16 can be positioned within the second latch cavity 64 of the central housing 12.

In use, the end of a first fiber optic cable (not shown) is crimped and glued within the first latch 14 such that the end of the fiber optic cable is proximate the inner end 86 of the first latch 14 and the end of a second fiber optic cable (not shown) is crimped and glued within the second latch 16 such that the end of the fiber optic cable is proximate the inner end 114 of the second latch 16. The first latch 14 is then aligned with and inserted into the first latch cavity 40 of the central housing 12 such that the teeth 98 are aligned with the recess 46, 48 of the side walls 30, 32. As the first latch 14 is moved within the first latch cavity 40, the central portion 90 of the bottom wall 80 engages the V-shaped rails 42, 44 and the top wall 78 engages the guiding structure 45 to align the latch 14 within the latch cavity 40. As the user continues to move the first latch 14 within the latch cavity 40, the sloped surfaces 100 of the teeth 98 slide along the inner surfaces of the side walls 30, 32 of the central housing 12. The user continues to slide the first latch 14 into the first latch cavity 40 until the teeth 98 spring into the apertures 38 of the central housing 12 at which point the retaining surfaces 102 of the teeth 98 engage the side walls of the aperture 38 and prevent the first latch 14 from moving out of the first latch cavity 40. It is to be understood that the teeth 98, 128 on the first and second latches 14, 16 could be provided on the side walls 30, 32, 54, 56 of the central housing and the apertures 38, 62 could be provided on the side walls of the first and second latches 14, 16.

The second latch 16 is then aligned with the second latch cavity 64 of the central housing 12 such that the teeth 128 are aligned with the recesses 68 on the inner surfaces of the side walls 54, 56. As the second latch 16 is moved within the second latch cavity 64, the central portion 120 of the top wall 106 of the second latch 16 will engage the V-shaped rails 66 of the central housing 12 and the guiding structure 67 will engage the bottom wall 108 to align the second latch 16 within the second latch cavity 64. As the user continues to move the latch 16 within the latch cavity 64, the sloped surfaces 130 of the teeth 128 slide along the inner surfaces of the side walls 54, 56 of the central housing 12. The user continues to slide the second latch 16 into the second latch cavity 64 until the teeth 128 spring into the apertures 62 of the central housing 12 at which point the retaining surfaces 132 of the teeth 128 engage the side walls of the apertures 62 and prevent the second latch 16 from moving out of the second latch cavity 64.

With the latches 14, 16 retained within the central housing 12, as shown in FIGS. 2 and 3, the first and second fibers are aligned with the internal wall aperture 72 and optical signals can be transmitted between the mated first and second fibers. The internal wall 72 provides a reduced aperture relative to the latch cavities 40, 64 and the fiber passageways 76, 104 through which the signal flows and therefore acts to reduce the EMI.

To disconnect the first latch 14 from the central housing 12 the user places his fingers on the finger latches 96 and presses the latch arms 94 towards each other causing the teeth 98 to move inwardly such that the retaining surface 102 of each tooth 98 no longer engages the side walls of the aperture 38. Once each tooth 98 has cleared the apertures 38, the latch 14 is pulled toward the first end 18 of the central housing 12 until the first latch 14 is clear of the first latch cavity 40.

To disconnect the second latch 16 from the central housing 12 the user places his fingers on the finger latches 126 and presses the latch arms 124 towards each other causing the teeth 128 to move inwardly such that the retaining surface 132 of each tooth 128 no longer engages the side walls of the apertures 62. Once each tooth 128 has cleared the aperture 62, the latch 16 is pulled toward the second end 20 of the central housing 12 until the second latch 16 is clear of the second latch cavity 64.

Attention is invited to the second embodiment of the invention shown in FIG. 4. The adaptor 200 includes a plurality of central housings 202, each with an associated first latch 204 and second latch 206. A flange 208 extends outwardly from the central housings 202. The central housings 202 and the flange 208 are formed from metal as a single unit. Four pairs of optical fibers can be mated within the adaptor 200. Each central housing 202 includes a first latch cavity 210 and a second latch cavity (not shown). The central housings 202, first latches 204 and second latches 206 are identical to the central housing 12, first latch 14 and second latch 16 of the adaptor 10, with the exception that the latch cavities, internal wall, and fiber passageways of the adaptor 200 are angled relative to the flange 208. Mounting apertures 210 are provided through the flange 208 for mounting the adaptor to a panel, for example.

The first and second latches 204, 206 are mounted and dismounted from the central housings 202 in the same manner as the first and second latches 14, 16 are mounted and dismounted from the central housing 12. Because the central housings 202 include an internal wall a reduced aperture is provided relative to the latch cavities of the central housings 202 and relative to the fiber passageways through the latches 204, 206. The reduced aperture provides shielding of EMI.

While preferred embodiments of the present invention are shown and described, it is envisioned that those skilled in the art may devise various modifications of the present invention without departing from the spirit and scope of the appended claims.

1. A fiber optic adaptor comprising:
a central housing formed of a unitary piece of metal, said central housing including a first latch portion having first latch portion side walls, a second latch portion having second latch portion side walls, an internal wall positioned between said first latch portion and said second latch portion, a first latch cavity partially defined by said first latch portion side walls and said internal wall, a second latch cavity partially defined by said second latch portion side walls and said internal wall, and an aperture provided through said internal wall, said aperture providing communication between said first latch cavity and said second latch cavity and said internal wall reducing electromagnetic interference;
a first latch for mating with said first latch cavity of said central housing, said first latch including a first fiber passageway partially defined by two spaced apart side walls each said side wall including a cantilevered latch arm which mates with said first latch portion of said central housing; and
a second latch for mating with said second latch cavity of said central housing, said second latch including a second fiber passageway partially defined by two spaced apart side walls and aligned with said first fiber passageway, each said side wall including a cantilevered latch arm which mates with said second latch portion of said central housing, said cantilevered latch arm including an offset finger latch.

2. A fiber optic adaptor as defined in claim 1, further including apertures provided through each said side wall of said first and second latch portions, a tooth extending outwardly from each said side wall of said first latch for engagement with said apertures through said side walls of said first latch portion and a tooth extends outwardly from each said side wall of said second latch for engagement with said apertures through said side walls of said second latch portion.

3. The adaptor of claim 1, wherein said first latch portion further includes two V-shaped rails for guiding said first latch within said first latch cavity and wherein said second latch portion further includes two V-shaped rails for guiding said second latch within said second latch cavity.

4. The adaptor of claim 1, wherein said first latch portion further includes a U-shaped guiding structure for guiding said first latch within said first latch cavity and wherein said second latch portion further includes a U-shaped guiding structure for guiding said second latch within said second latch cavity.

5. The adaptor of claim 1, wherein each said latch arm further includes an offset finger latch.

6. The adaptor of claim 1, further including a flange extending outwardly from the central housing.

7. The adaptor of claim 1, wherein said aperture through said internal wall is generally rectangularly shaped.

8. The adaptor of claim 1, wherein said internal wall is aligned with said flange.

9. A fiber optic adaptor comprising a plurality of central housing portions formed of a unitary piece of metal and first and second latches for mating with each said central housing portion; each said central housing including a first latch portion having first latch portion side walls, a second latch portion having second latch portion side walls, an internal wall positioned between said first latch portion and said second latch portion, a first latch cavity partially defined by said first latch portion side walls and said internal wall, a second latch cavity partially defined by said second latch portion side walls and said internal wall, and an aperture provided through said internal wall, said aperture provides communication between said first latch cavity and said second latch cavity and said internal wall reducing electromagnetic interference;
wherein each said first latch includes a first fiber passageway partially defined by two side walls and each said side wall including a cantilevered latch arm; and
wherein each said second latch includes a second fiber passageway partially defined by two side walls and aligned with said first fiber passageway, and each said side wall including a cantilevered latch arm having an offset finger latch.

10. A fiber optic adaptor as defined in claim 9, further including a mounting flange extending outwardly from said plurality of central housing portions and including apertures there through for mounting said adaptor.

11. A fiber optic adaptor as defined in claim 9, wherein said internal wall are angled relative to said flange.

12. A fiber optic adaptor as defined in claim 9, wherein each said first fiber passageway and each said second fiber passageway is angled relative to said mounting flange.

13. A fiber optic adaptor as defined in claim 9, further including an aperture through each said side wall of each said first and second latch portions, a tooth extending outwardly from each said side wall of each said first latch for engagement with said aperture through said side walls of each said first latch portion and a tooth extends outwardly from said side walls of each said second latch for engagement with said apertures through said side walls of each said second latch portion.

14. The adaptor of claim 9, wherein each said first latch portion further includes two V-shaped rails for guiding each said first latch within each said first latch cavity and wherein each said second latch portion further includes two V-shaped rails for guiding each said second latch within each said second latch cavity.

15. The adaptor of claim 9, wherein each said first latch portion further includes a U-shaped guiding structure for guiding each said first latch within each said first latch cavity and wherein each said second latch portion further includes a U-shaped guiding structure for guiding each said second latch within each said second latch cavity.

16. The adaptor of claim 9, wherein each said latch arm further includes an offset finger latch.

17. The adaptor of claim 9, wherein the aperture through each said internal wall is generally rectangularly shaped.
